(19) United States
(12) Patent Application Publication
(10) Pub. No.: US 2004/0217506 A1
(43) Pub. Date: Nov. 4, 2004

(54) Method of treating an elastomeric matrix

(75) Inventor: Maris Vistins, Alpharetta, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/429,502

(22) Filed: May 2, 2003

(51) Int. Cl. B29C 41/14

(52) U.S. Cl. 264/129; 264/307

(57) ABSTRACT

A method of treating an elastomeric matrix is disclosed. The method includes providing a transfer substrate including a treatment, providing an elastomeric matrix on a former, the matrix having an exposed surface, and contacting the matrix to the transfer substrate such that the treatment is transferred from the substrate to the exposed surface.

### BACKGROUND

Tightly fitting elastomeric articles, such as surgical and examination gloves, may be difficult to dispense or don due to “blocking”, the tendency of the interior surface, or donning surface, of the glove to feel sticky or tacky. As a result, various techniques have been employed to reduce glove blocking. One such technique includes applying a lubricant to the interior surface of the glove. Application of a lubricant using traditional immersion techniques often results in inadvertent treatment of the gripping surface, thereby potentially compromising the wearer's ability to securely grasp objects.

Furthermore, it may be advantageous to coat the article with other treatments, such as antimicrobial agents or skin health agents, without also treating the gripping side. As such, a need exists for a simplified, cost-effective technique for modifying the surface characteristics of a glove. In addition, a need exists to be able to treat one surface of an article without inadvertently treating another.

### SUMMARY OF THE INVENTION

The present invention generally relates to a method of modifying the surface characteristics of an elastomeric article, for example, a glove or a condom.

Specifically, the present invention relates to a method of applying a treatment to an elastomeric matrix. The method includes providing a transfer substrate including a treatment, providing the elastomeric matrix on a former, the elastomeric matrix having an exposed surface, and contacting the matrix to the transfer substrate such that the treatment is transferred from the substrate to the exposed surface. The transfer substrate may be formed from any suitable material, and in some instances, may include an open cell material, a nonwoven material, a flexible bristle, and so forth.

The present invention further relates to a method of treating a surface of an elastomeric matrix including providing a transfer substrate, metering a treatment to the transfer substrate, providing the elastomeric matrix on a former, the elastomeric matrix having an exposed surface, and contacting the matrix to the transfer substrate such that the treatment is transferred from the substrate to the exposed surface. The method contemplates removing excess treatment from the transfer substrate.

The present invention also relates to a method of applying a treatment to a plurality of elastomeric matrices. The method includes providing a conveyable assembly including a plurality of formers, each former coated with an elastomeric matrix, metering a treatment to a transfer substrate, and advancing the assembly to bring each elastomeric matrix into contact with the transfer substrate such that the treatment is transferred from the transfer substrate to each elastomeric matrix. The method contemplates removing excess treatment from the transfer substrate.

The present invention also relates to a method of forming a treated elastomeric article. The method includes providing a transfer substrate including a treatment, providing an elastomeric matrix on a former, the elastomeric matrix having an exposed surface, contacting the matrix to the transfer substrate such that the treatment is transferred from the substrate to the exposed surface, and solidifying the matrix to form the treated article. Any treatment may be used, and in some instances, the treatment includes a lubricant, a skin health agent, and/or an antimicrobial agent.

### BRIEF DESCRIPTION OF THE DRAWINGS

FIG. 1 depicts an elastomeric article, namely a glove, that may be used with the present invention.

FIG. 2 depicts an assembly for treating a plurality of elastomeric matrices.

FIG. 3 depicts a method of treating an elastomeric article in which the transfer substrate includes an open cell material.

FIG. 4 depicts a method of treating an elastomeric article in which the transfer substrate includes an open cell material mounted on rollers.

FIG. 5 depicts a method of treating an elastomeric article in which the treatment is supplied to an open cell material as a chemical foam.

FIG. 6 depicts a method of treating an elastomeric article in which the transfer substrate includes a plurality of flexible bristles.

FIG. 7 depicts a method of treating an elastomeric article in which the transfer substrate includes a plurality of fabric strips.

### DESCRIPTION

The present invention generally relates to a method of modifying the surface characteristics of an elastomeric article, for example, a condom, or a glove for use in medical and/or scientific applications. As used herein, the term “elastomeric article” refers to an article having at least one surface formed predominantly from an elastomeric material. As used herein, the term “elastomeric material” refers to a polymeric material that is capable of being easily stretched or expanded, and will substantially return to its previous shape upon release of the stretching or expanding force. Specifically, the technique contemplated by the present invention enables a surface of the article to be treated without having to resort to more cumbersome, traditional coating techniques. Furthermore, the treatment may be applied to one surface without the risk of inadvertently treating another surface. As used herein, the term “treatment” refers to any chemical or other agent that may be applied to the surface of an article that imparts some functionality thereto. Examples of treatments include, but are not limited to, colorants, surfactants, antimicrobial agents, skin health agents, repellents, lubricants, antistatic agents, friction enhancers, and so forth.

To apply a treatment to an elastomeric article, for example, a glove, a glove matrix on a hand-shaped glove former is brought into contact with a transfer substrate saturated with the treatment to be applied. As used herein, “matrix” refers to a coating of an elastomeric material on the surface of the former at any stage of the formation process, and may include multiple layers or components, and may be tacky, semi-solid, or solid, cured or uncured, and so forth. This process may be used to apply one or more treatments to the article while it is in the form of a matrix. To better understand the present invention, the entirety of the process is described below.

An elastomeric article, for example, a glove, may be formed using a variety of processes, for example, dipping, spraying, tumbling, drying, and curing. An exemplary dipping process for forming a glove is described herein, though other processes may be employed to form various articles having different shapes and characteristics. For example, a condom may be formed in substantially the same manner, although some process conditions may differ from those used to form a glove. It should also be understood that a batch, semi-batch, or a continuous process may be used with the present invention.

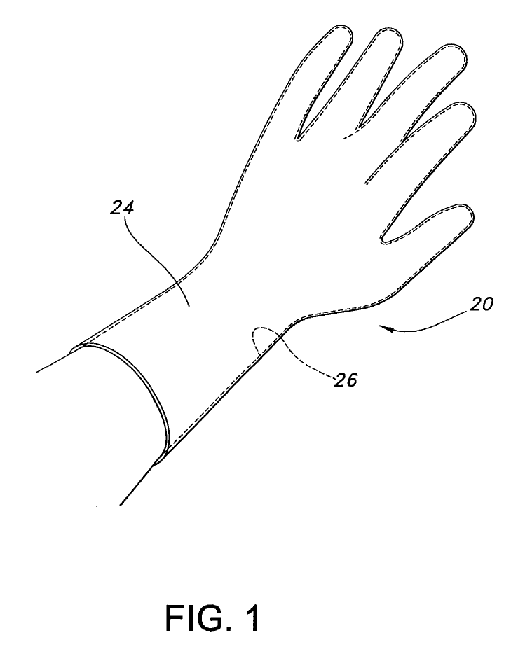

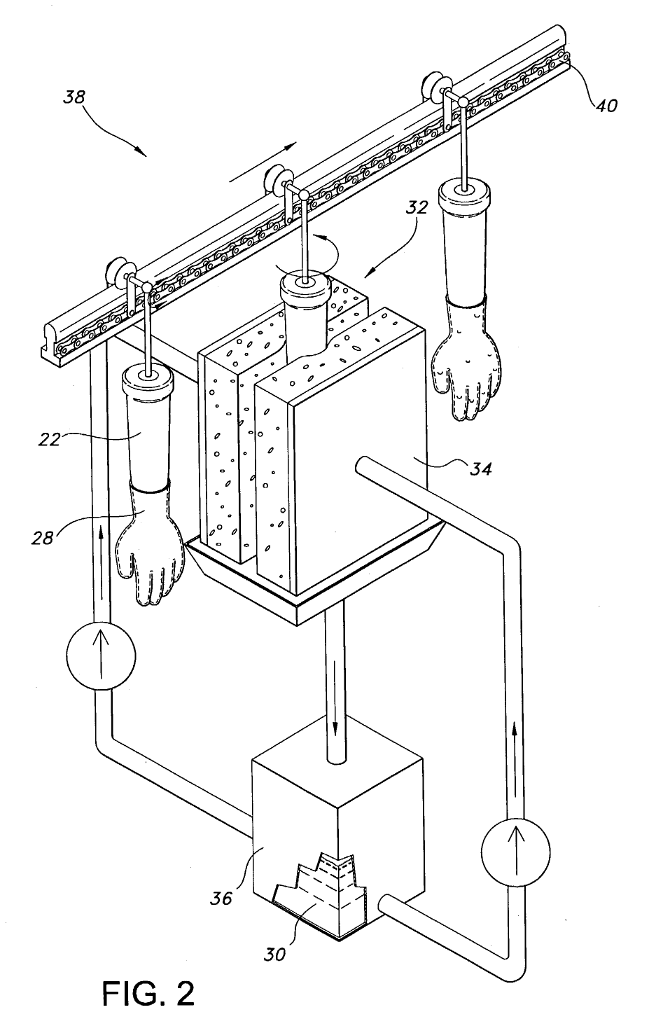

A glove 20 (FIG. 1) is formed on a hand-shaped mold, termed a “former”. The former 22 (FIG. 2) may be made from any suitable material, such as glass, metal, porcelain, or the like. The surface of the former defines at least a portion of the surface of the glove 20 to be manufactured. The glove 20 includes an exterior surface 24 and an interior (i.e., wearer-contacting) surface 26.

The former 22 is coated with an elastomeric material, often using a dipping process, to form an elastomeric matrix 28 on the surface of the former. Any suitable elastomeric material or combination of materials may be used to form the elastomeric glove matrix. In one embodiment, the elastomeric material may include natural rubber, which may generally be provided as natural rubber latex. In another embodiment, the elastomeric material may include nitrile butadiene rubber, and in particular, may include carboxylated nitrile butadiene rubber. In other embodiments, the elastomeric material may include a styrene-ethylene-butylene-styrene block copolymer, styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, or a combination thereof.

The former may be subjected to multiple dipping processes to build up the desired glove thickness on the former, or to create layers of the glove having various properties, and so forth.

At any point during the glove formation process, it may be desirable to apply one or more treatments to the exposed surface of the matrix. In many cases, the exposed surface becomes the interior surface (wearer-contacting) of the glove, so it may be advantageous to apply a treatment that enhances the interior surface of the resulting glove. However, it should be understood that the exposed surface may become the exterior surface of the glove when donned, depending on the number of times the glove is inverted during post formation processes, and it therefore may be advantageous to apply a treatment that enhances the exterior surface of the resulting glove.

While traditional treatment processes involve stripping the glove from the former and subjecting the glove to cumbersome immersion processes, the method of the present invention allows the treatment to be applied while the glove matrix is still on the former. As depicted in FIG. 2, the desired treatment 30 is first supplied to a transfer substrate 32. The transfer substrate may be affixed to or mounted onto a rigid or lo semi-rigid surface, such as plate 34, where desired. Such a plate may include features (not shown) to distribute the treatment across the entire transfer substrate to ensure uniform delivery of the treatment to the matrix. The elastomeric matrix 28 on the former 22 is then contacted to the transfer substrate 32, thereby transferring the treatment 30 from the transfer substrate 32 to the elastomeric matrix 28.

The treatment to be applied may be metered to the substrate from a supply source 36, for example, a tank or other suitable vessel, during the treatment process (FIG. 2). The treatment may be metered continuously or intermittently as desired. Thus, the present invention further contemplates a method of treating multiple glove matrices on multiple glove formers. Such a method may include providing a conveyable assembly 38, for instance, a plurality of formers 22 on a motor driven chain 40. The formers may generally be able to pivot and rotate with respect to the chain to facilitate uniform matrix thickness over the area of the glove. Using any suitable technique, for example dipping, each former may be coated with an elastomeric matrix 28. A treatment 30 is metered to a transfer substrate 32, and the assembly 38 is advanced to bring each elastomeric matrix 28 into contact with the transfer substrate 32. The treatment 30 is then transferred from the transfer substrate 32 to each elastomeric matrix 28.

The method also contemplates removing excess treatment from the transfer substrate where needed or desired (not shown). In some instances, removal of excess treatment may be performed to ensure that the proper quantity of treatment is available for transfer to the next matrix to be coated. In other instances, removal of treatment may be performed to ensure that the treatment transferred to the matrix is of a consistent quality.

The transfer substrate may be formed from any material capable of delivering the treatment to the matrix without compromising the physical integrity of the matrix. The transfer substrate may be flexible, compressible, and/or deformable, depending on the needs of the application. Where the treatment is to be applied during early stages of formation, for example, while the matrix is wet or tacky, a suitable substrate should be selected to avoid damaging the matrix upon contact.

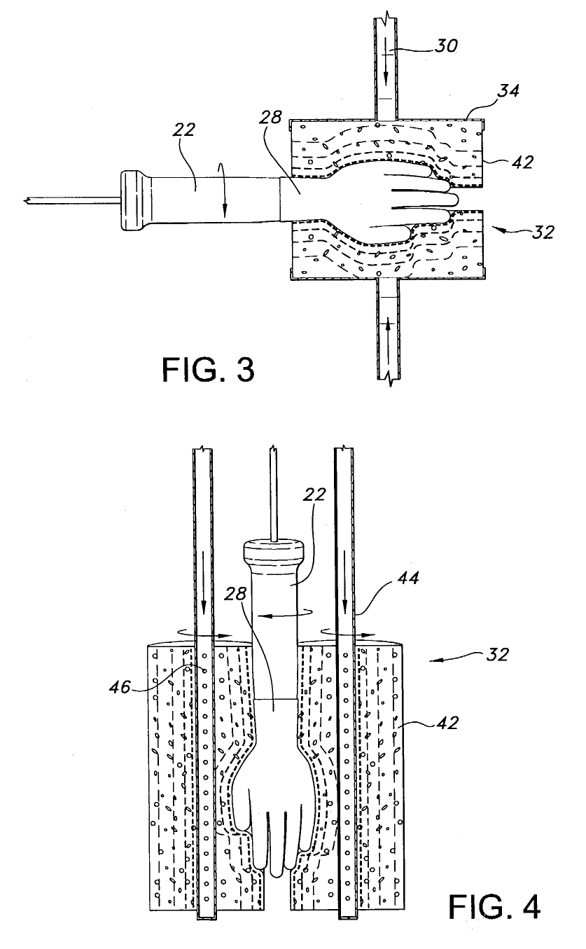

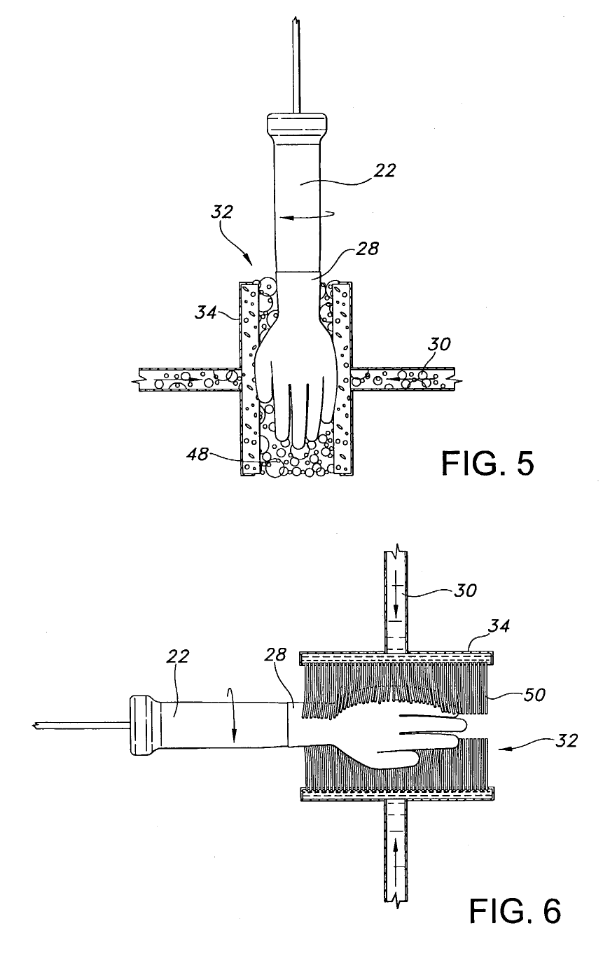

In one embodiment, the transfer substrate may include an open cell material, for example, an open cell foam, sponge, pad, or the like. In such an embodiment, the open cell material 42 may be affixed to or mounted onto a rigid or semi-rigid plate 34 to which the treatment 30 is supplied (FIG. 3). Such open cell materials are generally compressible, thereby being able to deform as needed to accommodate the contours of the rotating former during treatment. Alternatively, as depicted in FIG. 4, the transfer substrate, for example, an open cell material 42 may be mounted onto a roller 44 that may, if desired, rotate freely or may be driven by a motor to rotate at a desired speed. Such a roller may include pores or holes 46 to permit passage of the treatment 30 through the roller surface to the transfer substrate 32. The holes may, in some instances, vary in size to promote the desired distribution of flow through the roller to the transfer substrate.

Where the matrix 28 is especially delicate, it may be beneficial to provide the treatment 30 to the transfer substrate 32 as a chemical foam 48 (FIG. 5). Various foaming techniques are available, and any suitable technique may be used. In some such instances, it may be necessary or desirable to minimize or eliminate contact with the transfer substrate and simply contact the chemical foam to the matrix.

In another embodiment, the transfer substrate 32 may include flexible bristles or fiber-like materials (FIG. 6). In such an embodiment, the bristles 50 or fibers may be secured to a rigid or semi-rigid plate 34, roller, or the like to which the treatment 30 is supplied. In this instance, the treatment-laden bristles contact the matrix as the matrix advances through the formation process. Any suitable material may be used to form the bristles, provided that the material is capable of transferring the treatment without damaging the elastomeric matrix.

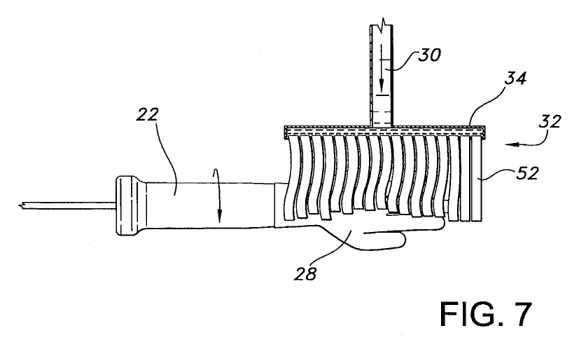

In another embodiment, the transfer substrate may include a nonwoven material, for example, nonwoven strips. In one embodiment, transfer substrate includes a strip of nonwoven material, for example, spunbond that is secured to a rigid or semi-rigid plate/backing to which the treatment is supplied. In another embodiment, multiple strips 52 of a nonwoven material may be used as the transfer substrate 32 (FIG. 7). Such strips may be mounted in any suitable means, and in some instances, may be mounted to a rigid or semi-rigid plate 34. As used herein, the term “nonwoven fabric” or “nonwoven web” or “nonwoven material” means a web having a structure of individual fibers or threads that are randomly interlaid, but not in an identifiable manner or pattern as in a knitted fabric. Nonwoven fabrics or webs have been formed from many processes, for example, meltblowing processes, spunbonding processes, and bonded carded web processes.

As used herein, the term “spunbond” or “spunbond fibers” or “spunbonded fibers” refers to small diameter fibers that are formed by extruding molten thermoplastic material as filaments from a plurality of fine, usually circular capillaries of a spinneret with the diameter of the extruded filaments then being rapidly reduced, for example, as in U.S. Pat. No. 4,340,563 to Appel et al.

As used herein, the term “meltblown” or “meltblown fibers” means fibers formed by extruding a molten thermoplastic material through a plurality of fine, usually circular, die capillaries as molten threads or filaments into converging high velocity, usually hot, gas (e.g. air) streams that attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al.

The nonwoven transfer substrate may be formed from a single layer of material or a composite of multiple layers. In the case of multiple layers, the layers may generally be positioned in a juxtaposed or surface-to-surface relationship and all or a portion of the layers may be bound to adjacent layers. The multiple layers of a composite may be joined to form a multilayer laminate by various methods, including but not limited to adhesive bonding, thermal bonding, or ultrasonic bonding. One composite material suitable for use with the present invention is a spunbond/meltblown/spunbond (SMS) laminate. Other examples include wovens, films, foam/film laminates and combinations thereof, for example, a spunbond/film/spunbond (SFS) laminate.

The treatment may be supplied to the transfer substrate at any suitable rate and by any suitable method, for example, a pump, a gravity feed tank, or any other suitable means. The treatment may be supplied to the transfer substrate at a constant rate or a variable rate as desired. Furthermore, the treatment may be supplied continuously or discontinuously as needed to provide the desired amount of treatment to the transfer substrate. Where the transfer substrate is mounted to a rigid or semi-rigid plate, the plate may include features that enable the treatment to be uniformly delivered to the entire transfer substrate. Such features may include, for example, distribution channels or baffles, multiple supply inlets, and so forth.

For some applications, it may be desirable to heat the treatment during the treatment process. For treatments having a reduced viscosity at lower temperatures, heating the treatment may improve transfer of the treatment from the substrate to the glove matrix. For some applications, the temperature of the treatment may be maintained at about 20° C. to about 80° C. For other applications, the temperature of the treatment may be maintained at about 30° C. to about 60° C. In yet other applications, the temperature of the treatment may be maintained at about 40° C. to about 50° C. Where it is desirable to heat the treatment during the treatment process, the transfer substrate may be selected to be resistant to degradation at the temperature to which it will be exposed.

The treatment may be transferred to each matrix at any level suitable for a given application. In some embodiments, the treatment may be applied to the glove so that the treatment is applied at a level of from about 1 mass % to about 50 mass % of the matrix. In other embodiments, the treatment may be applied at a level of from about 10 mass % to about 30 mass % of the matrix. In yet other embodiments, the treatment may be applied at a level of from about 15 mass % to about 25 mass % of the matrix.

The treatment may be transferred to each finished glove at any level suitable for a given application. In some embodiments, the treatment may be applied to the glove so that the treatment is applied at a level of from about 0.01 mass % to about 5.0 mass % of the treated glove. In other embodiments, the treatment may be applied at a level of from about 0.1 mass % to about 3.0 mass % of the treated glove. In yet other embodiments, the treatment may be applied at a level of from about 0.25 mass % to about 1.0 mass % of the treated glove.

Where it is difficult to achieve the desired treatment level using a single contact with a transfer substrate, multiple treatment processes may be used. In some instances, the matrix may be subjected to successive contacts with multiple transfer substrates. Multiple treatment steps may be separated by heating or drying, or by additional dipping processes, as desired.

Alternatively, it may be necessary or desirable to remove excess treatment from the transfer substrate prior to contacting the glove matrix. Removal of excess treatment may ensure an accurate and precise level of treatment to be available to the matrix as it approaches the transfer substrate for contact. Removal of excess treatment may be achieved in any suitable manner, for example, by contacting the transfer substrate to an absorbent material prior to contacting the matrix, by passing the transfer substrate across a rigid edge, such as a knife or blade, by pressing the transfer substrate between rigid or senu-rigid surfaces to force excess treatment to be removed from the transfer substrate, and so forth.

Various treatments or combination of treatments may be used with the present invention. The treatment may be applied as an aqueous solution, a dispersion, an emulsion, or may be applied as an anhydrous composition.

In one embodiment, the treatment may include a lubricant composition to facilitate donning the glove. In one such embodiment, the lubricant may include a silicone or silicone-based component. As used herein, the term “silicone” generally refers to a broad family of synthetic polymers that have a repeating silicon-oxygen backbone, including, but not limited to, polydimethylsiloxane and polysiloxanes having hydrogen-bonding functional groups selected from the group consisting of amino, carboxyl, hydroxyl, ether, polyether, aldehyde, ketone, amide, ester, and thiol groups. In some embodiments, polydimethylsiloxane and/or modified polysiloxanes may be used. Some suitable modified polysiloxanes that may be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof.

Examples of some suitable phenyl-modified polysiloxanes include, but are not limited to, dimethyldiphenylpolysiloxane copolymers, dimethyl and methylphenylpolysiloxane copolymers, polymethylphenylsiloxane, and methylphenyl and dimethylsiloxane copolymers. Phenyl modified polysiloxanes that have a relatively low phenyl content (less than about 50 mole %) may also be used with the present invention. For example, the phenyl-modified polysiloxane may be a diphenyl-modified silicone, such as a diphenylsiloxane-modified dimethylpolysiloxane. In some embodiments, the phenyl-modified polysiloxane may contain phenyl units in an amount from about 0.5 mole % to about 50 mole %. In other embodiments, the phenyl-modified polysiloxane may contain phenyl units in an amount less than about 25 mole %. In yet other embodiments, the phenyl-modified polysiloxane may contain phenyl units in an amount less than about 15 mole %. In one particular embodiment, a diphenylsiloxane-modified dimethylpolysiloxane may be used that contains diphenylsiloxane units in an amount less than about 5 mole %. In still another embodiment, a diphenylsiloxane-modified dimethylpolysiloxane may be used that contains diphenylsiloxane units in an amount less than about 2 mole %. The diphenylsiloxane-modified dimethylpolysiloxane may be synthesized by reacting diphenylsiloxane with dimethylsiloxane.

As indicated above, fluoro-modified polysiloxanes may also be used with the present invention. For instance, one suitable fluoro-modified polysiloxane that may be used is a trifluoropropyl modified polysiloxane, such as a trifluoropropylsiloxane modified dimethylpolysiloxane. A trifluoropropylsiloxane modified dimethylpolysiloxane may be synthesized by reacting methyl, 3,3,3 trifluoropropylsiloxane with dimethylsiloxane. The fluoro-modified silicones may contain from about 5 mole % to about 95 mole % of fluoro groups, such as trifluoropropylsiloxane units. In another embodiment, the fluoro-modified silicones may contain from about 40 mole % to about 60 mole % of fluoro groups. In yet another embodiment, a trifluoropropylsiloxane-modified dimethylpolysiloxane may be used that contains 50 mole % trifluoropropylsiloxane units.

Other modified polysiloxanes may be used with the present invention. For instance, some suitable vinyl-modified polysiloxanes include, but are not limited to, vinyldimethyl terminated polydimethylsiloxanes, vinylmethyl and dimethylpolysiloxane copolymers, vinyldimethyl terminated vinylmethyl and dimethylpolysiloxane copolymers, divinylmethyl terminated polydimethylsiloxanes, and vinylphenylmethyl terminated polydimethylsiloxanes. Further, some methyl-modified polysiloxanes that may be used include, but are not limited to, dimethylhydro terminated polydimethylsiloxanes, methylhydro and dimethylpolysiloxane copolymers, methylhydro terminated methyloctyl siloxane copolymers and methylhydro and phenylmethyl siloxane copolymers. In addition, some examples of amino-modified polysiloxanes include, but are not limited to, polymethyl [3-aminopropyl)-siloxane and polymethyl β-(2-aminoethyl) aminopropyl]-siloxane.

The particular polysiloxanes described above are meant to include hetero- or co-polymers formed from polymerization or copolymerization of dimethylsiloxane cyclics and diphenylsiloxane cyclics or trifluoropropylsiloxane cyclics with appropriate endcapping units. Thus, for example, the terms “diphenyl modified dimethylpolysiloxanes” and “copoloymers of diphenylpolysiloxane and dimethylpolysiloxane” may be used interchangeably. Moreover, other examples of polysiloxanes that may be used with the present invention are described in U.S. Pat. No. 5,742,943 to Chen and U.S. Pat. No. 6,306,514 to Weikel, et al., which are incorporated herein by reference in their entirety.

One silicone that may be used with the present invention is provided as an emulsion under the trade name DC 365. DC 365 is a pre-emulsified silicone (35% total solids content (“TSC”)) that is commercially available from Dow Corning Corporation (Midland, Mich.). DC 365 is believed to contain 40-70 mass % water (aqueous solvent), 30-60 mass % methyl-modified polydimethylsiloxane (silicone), 1-5 mass % propylene glycol (non-aqueous solvent), 1-5 mass % polyethylene glycol sorbitan monolaurate (nonionic surfactant), and 1-5 mass % octylphenoxy polyethoxy ethanol (nonionic surfactant). Another silicone emulsion that may be used with the present invention is SM 2140, commercially available from General Electric Silicones of Waterford, New York (“GE Silicones”). SM 2140 is a pre-emulsified silicone (25% TSC) that is believed to contain 30-60 mass % water (aqueous solvent), 30-60 mass % amino-modified dimethylpolysiloxane (silicone), 1-5% ethoxylated nonyl phenol (nonionic surfactant), 1-5 mass % trimethyl-4-nonyloxypolyethyleneoxy ethanol (nonionic surfactant), and minor percentages of acetaldehyde, formaldehyde, and 1,4 dioxane. If desired, these pre-emulsified silicones may be diluted with water or other solvents prior to use.

In another embodiment, the treatment may contain a quaternary ammonium compound, such as that commercially available from Goldschmidt Chemical Corporation of Dublin, Ohio under the trade name Verisoft BTMS, and a silicone emulsion such as that commercially available from GE Silicones under the trade name AF-60. Verisoft BTMS contains behnyl trimethyl sulfate and cetyl alcohol, while AF-60 contains polydimethylsiloxane, acetylaldehyde, and small percentages of emulsifiers.

In another embodiment, the treatment may include a surfactant, for example, a cationic surfactant (e.g., cetyl pyridinium chloride), an anionic surfactant (e.g., sodium lauryl sulfate), a nonionic surfactant, or an amphoteric surfactant. Where the surface of the glove is anionic, as with a natural rubber glove or a nitrile glove, it may be advantageous to select one or more cationic surfactants. It is believed that this may, in some instances, improve transfer of the treatment to the glove. Cationic surfactants that may be used include, for example, behenetrimonium methosulfate, distearyldimonium chloride, dimethyl dioctadecyl ammonium chloride, cetylpyridinium chloride, methylbenzethonium chloride, hexadecylpyridinium chloride, hexadecyltrimethylammonium chloride, benzalkonium chloride, dodecylpyridinium chloride, the corresponding bromides, hydroxyethylheptadecylimidazolium halides, coco aminopropyl betaine, and coconut alkyldimethylammonium betaine. Additional cationic surfactants that may be used include methyl bis(hydrogenated tallow amidoethyl)-2-hydroxyethly ammonium methyl sulfate, methyl bis(tallowamido ethyl)-2-hydroxyethyl ammonium methyl sulfate, methyl bis(soya amidoethyl)-2-hydroxyethyl ammonium methyl sulfate, methyl bis(canola amidoethyl)-2-hydroxyethyl ammonium methyl sulfate, methyl bis(tallowamido ethyl)-2-tallow imidazolinium methyl sulfate, methyl bis(hydrogenated tallowamido ethyl)-2-hydrogenated tallow imidazolinium methyl sulfate, methyl bis(ethyl tallowate)-2-hydroxyethyl ammonium methyl sulfate, methyl bis(ethyl tallowate)-2-hydroxyethyl ammonium methyl sulfate, dihydrogenated tallow dimethyl ammonium chloride, didecyl dimethyl ammonium chloride, dioctyl dimethyl ammonium chloride, octyl decyl dimethyl ammonium chloride diamidoamine ethoxylates, diamidoamine imidazolines, and quaternary ester salts.

In some embodiments, one or more nonionic surfactants may be used. Nonionic surfactants typically have a hydrophobic base, such as a long chain alkyl group or an alkylated aryl group, and a hydropholic chain comprising a certain number (e.g., 1 to about 30) of ethoxy and/or propoxy moieties. Examples of some classes of nonionic surfactants that may be used include, but are not limited to, ethoxylated alkylphenols, ethoxylated and propoxylated fatty alcohols, polyethylene glycol ethers of methyl glucose, polyethylene glycol ethers of sorbitol, ethylene oxide-propylene oxide block copolymers, ethoxylated esters of fatty (C₈-C₁₈) acids, condensation products of ethylene oxide with long chain amines or amides, condensation products of ethylene oxide with alcohols, and mixtures thereof.

Specific examples of suitable nonionic surfactants include, but are not limited to, methyl gluceth-10, PEG-20 methyl glucose distearate, PEG-20 methyl glucose sesquistearate, C₁₁₋₁₅ pareth-20, ceteth-8, ceteth-12, dodoxynol-12, laureth-15, PEG-20 castor oil, polysorbate 20, steareth-20, polyoxyethylene-10 cetyl ether, polyoxyethylene-10 stearyl ether, polyoxyethylene-20 cetyl ether, polyoxyethylene-10 oleyl ether, polyoxyethylene-20 oleyl ether, an ethoxylated nonylphenol, ethoxylated octylphenol, ethoxylated dodecylphenol, or ethoxylated fatty (C₆-C₂₂) alcohol, including 3 to 20 ethylene oxide moieties, polyoxyethylene-20 isohexadecyl ether, polyoxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-15 tridecyl ether, polyoxy-ethylene-6 tridecyl ether, laureth-2, laureth-3, laureth-4, PEG-3 castor oil, PEG 600 dioleate, PEG 400 dioleate, oxyethanol, 2,6,8-trimethyl-4-nonyloxypolyethylene oxyethanol; octylphenoxy polyethoxy ethanol, nonylphenoxy polyethoxy ethanol, 2,6,8-trimethyl-4-nonyloxypolyethylene alkyleneoxypolyethyleneoxyethanol, alkyleneoxypolyethyleneoxyethanol; alkyleneoxypolyethyleneoxyethanol, and mixtures thereof.

Additional nonionic surfactants that may be used include water soluble alcohol ethylene oxide condensates that are the condensation products of a secondary aliphatic alcohol containing between about 8 to about 18 carbon atoms in a straight or branched chain configuration condensed with between about 5 to about 30 moles of ethylene oxide. Such nonionic surfactants are commercially available under the trade name Tergitol® from Union Carbide Corp., Danbury, Conn. Specific examples of such commercially available nonionic surfactants of the foregoing type are C₁₁-C₁₅ secondary alkanols condensed with either 9 moles of ethylene oxide (Tergitol® 15-S-9) or 12 moles of ethylene oxide (Tergitol® 15-S-12) marketed by Union Carbide Corp., (Danbury, Conn.).

Other suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include nonyl condensed with about 9.5 moles of ethylene oxide per mole of nonyl phenol, dinonyl phenol condensed with about 12 moles of ethylene oxide per mole of phenol, dinonyl phenol condensed with about 15 moles of ethylene oxide per mole of phenol and diisoctylphenol condensed with about 15 moles of ethylene oxide per mole of phenol. Commercially available nonionic surfactants of this type include Igepal® CO-630 (a nonyl phenol ethoxylate) marketed by ISP Corp. (Wayne, N.J.). Suitable non-ionic ethoxylated octyl and nonyl phenols include those having from about 7 to about 13 ethoxy units.

In some embodiments, one or more amphoteric surfactants may be used. One class of amphoteric surfactants that may suitable for use with the present invention includes the derivatives of secondary and tertiary ammes having aliphatic radicals that are straight chain or branched, where one of the aliphatic substituents contains from about 8 to 18 carbon atoms and at least one of the aliphatic substituents contains an anionic water-solubilizing group, such as a carboxy, sulfonate, or sulfate group. Some examples of amphoteric surfactants include, but are not limited to, sodium 3-(dodecylamino)propionate, sodium 3-(dodecylamino)-propane-1-sulfonate, sodium 2-(dodecylarmino)ethyl sulfate, sodium 2-(dimethylamino)octadecanoate, disodium 3-(N-carboxymethyl-dodecylamino)propane-1-sulfonate, sodium 1-carboxymethyl-2-undecylimidazole, disodium octadecyliminodiacetate, and sodium N,N-bis(2-hydroxyethyl)-2-sulfato-3-dodecoxypropylamine.

Additional classes of suitable amphoteric surfactants include phosphobetaines and phosphitaines. For instance, some examples of such amphoteric surfactants include, but are not limited to, sodium coconut N-methyl taurate, sodium oleyl N-methyl taurate, sodium tall oil acid N-methyl taurate, cocodimethylcarboxymethylbetaine, lauryldimethylcarboxymethylbetaine, lauryldimethylcarboxyethylbetaine, cetyldimethylcarboxymethylbetaine, sodium palmitoyl N-methyl taurate, oleyldimethylgammacarboxypropylbetaine, lauryl-bis-(2-hydroxypropyl)-carboxyethylbetaine, di-sodium oleamide PEG-2 sulfosuccinate, laurylamido-bis-(2-hydroxyethyl) propylsultaine, lauryl-bis-(2 -hydroxyethyl) carboxymethylbetaine, cocoamidodimethylpropylsultaine, stearylamidodimethylpropylsultaine, TEA oleamido PEG-2 sulfosuccinate, disodium oleamide MEA sulfosuccinate, disodium oleamide MIPA sulfosuccinate, disodium ricinoleamide MEA sulfosuccinate, disodium undecylenamide MEA sulfosuccinate, disodium wheat germamido MEA sulfosuccinate, disodium wheat germamido PEG-2 sulfosuccinate, disodium isostearamideo MEA sulfosuccinate, cocoamido propyl monosodium phosphitaine, lauric myristic amido propyl monosodium phosphitaine, cocoamido disodium 3-hydroxypropyl phosphobetaine, lauric myristic amido disodium 3-hydroxypropyl phosphobetaine, lauric myristic amido glyceryl phosphobetaine, lauric myristic amido carboxy disodium 3-hydroxypropyl phosphobetaine, cocoamphoglycinate, cocoamphocarboxyglycinate, capryloamphocarboxyglycinate, lauroamphocarboxyglycinate, lauroamphoglycinate, capryloamphocarboxypropionate, lauroamphocarboxypropionate, cocoamphopropionate, cocoamphocarboxypropionate, dihydroxyethyl tallow glycinate, and mixtures thereof.

In certain instances, one or more anionic surfactants may be used. Suitable anionic surfactants include, but are not limited to, alkyl sulfates, alkyl ether sulfates, alkyl ether sulfonates, sulfate esters of an alkylphenoxy polyoxyethylene ethanol, alpha-olefin sulfonates, beta-alkoxy alkane sulfonates, alkylauryl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxyethylene sulfates, isethionates, or mixtures thereof.

Particular examples of some suitable anionic surfactants include, but are not limited to, C₈-C₁₈ alkyl sulfates, C₈-C₁₈ fatty acid salts, C₈-C₁₈ alkyl ether sulfates having one or two moles of ethoxylation, C₈-C₁₈ alkamine oxides, C₈-C₁₈ alkoyl sarcosinates, C₈-C₁₈ sulfoacetates, C₈-C₁₈ sulfosuccinates, C₈-C₁₈ alkyl diphenyl oxide disulfonates, C₈-C₁₈ alkyl carbonates, C₈-C₁₈ alpha-olefin sulfonates, methyl ester sulfonates, and blends thereof. The C₈-C₁₈ alkyl group may be straight chain (e.g., lauryl) or branched (e.g., 2-ethylhexyl). The cation of the anionic surfactant may be an alkali metal (e.g., sodium or potassium), ammonium, C₁-C₄ alkylammonium (e.g., mono-, di-, tri), or C₁-C₃ alkanolammonium (e.g., mono-, di-, tri).

Specific examples of such anionic surfactants include, but are not limited to, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, ricinoleates, cetyl sulfates, and so forth.

In another embodiment, the treatment may include an antimicrobial agent or composition. Any suitable antimicrobial composition may be used. In some embodiments, a treatment that reduces microbe affinity and viable transmission may be used. One such treatment may include a silane quaternary ammonium compound. One such treatment that may be used is Microbeshield™, available from Aegis Environments (Midland, Mich.) as various compositions of 3-(trimethoxysilyl) propyldimethyloctadecyl ammonium chloride in methanol. Two such compositions include AEM 5700 (43% total solids content) and AEM 5772 (72% total solids content).

In yet another embodiment, the treatment may include a skin health agent or composition. In one embodiment, the skin health agent may be an emollient. As used herein, an “emollient” refers to an agent that helps restore dry skin to a more normal moisture balance. Emollients act on the skin by supplying fats and oils that blend in with skin, making it pliable, repairing some of the cracks and fissures in the stratum corneum, and forming a protective film that traps water in the skin. Emollients that may be suitable for use with the present invention include beeswax, butyl stearate, cermides, cetyl palmitate, eucerit, isohexadecane, isopropyl palmitate, isopropyl myristate, mink oil, mineral oil, nut oil, oleyl alcohol, petroleum jelly or petrolatum, glyceral stearate, avocado oil, jojoba oil, lanolin (or woolwax), lanolin derivatives such as lanolin alcohol, retinyl palmitate (a vitamin A derivative), cetearyl alcohol, squalane, squalene, stearic acid, stearyl alcohol, myristal myristate, certain hydrogel emollients, various lipids, decyl oleate and castor oil.

In yet another embodiment, the treatment may include a humectant. As used herein, a “humectant” refers to an agent that lo supplies the skin with water by attracting moisture from the air and retaining it in the skin. Humectants that may be suitable for use with the present invention include alanine, glycerin, PEG, propylene glycol, butylenes glycol, glycerin (glycol), hyaluronic acid, Natural Moisturizing Factor (a mixture of amino acids and salts that are among the skin's natural humectants), saccharide isomerate, sodium lactate, sorbitol, urea, and sodium PCA.

In still another embodiment, the treatment may include an antioxidant. As used herein, an “antioxidant” refers to an agent that prevents or slows the oxidation process, thereby protecting the skin from premature aging. Exemplary antioxidants for use in the present invention include ascorbic acid ester, vitamin C (ascorbic acid), vitamin E (lecithin), Alpha-Glycosyl Rutin (AGR, or Alpha Flavon, a plant-derived antioxidant), and coenzyme Q10 (also known as ubiquinone).

In still another embodiment, the treatment may include a skin conditioner. As used herein, a “skin conditioner” refers to an agent that may help the skin retain moisture, improve softness, or improve texture. Skin conditioners include, for example, amino acids, including alanine, serine, and glycine; allantoin, keratin, and methyl glucose dioleate; alpha-hydroxy acids, including lactic acid and glycolic acid, which act by loosening dead skin cells from the skin's surface; moisturizers (agents that add or hold water in dry skin), including echinacea (an extract of the coneflower plant), shea butter, and certain silicones, including cyclomethicon, dimethicone, and simethicone.

In other embodiments, the treatment may include Aloe vera; chelating agents, such as EDTA; absorptive/neutralizing agents, such as kaolin, hectorite, smectite, or bentonite; other vitamins and vitamin sources and derivatives, such as panthenol, retinyl palmitate, tocopherol, and tocopherol acetate; anti-irritants such as chitin and chitosan; extracts, such as almond and chamomile; and other agent, such as elder flowers, honey, safflower oil, and elastin.

In one embodiment, a skin health agent may be retained in the treatment in a liposome carrier. A liposome is a microscopic sphere formed from a fatty compound, i.e., a lipid, surrounding a water-based agent, such as a moisturizer or an emollient. When the liposome is rubbed into the skin, it releases the agent throughout the stratum corneum.

In another embodiment, a skin health agent may retained in the treatment as a microencapsulant. A microencapsulant is a sphere of an emollient surrounded by a gelatin membrane that prevents the emollient from reacting with other ingredients in the coating composition and helps distribute the emollient more evenly when pressure is applied and the membrane is broken. The process of forming these beads is known as “microencapsulation”.

Alternatively, any other treatment or combination of treatments may be applied to the exposed surface to impart the desired attribute to the glove.

The treatment method of the present invention offers significant advantages over traditional treatment techniques, which generally require the gloves to be removed from the formers and manually placed into an immersion apparatus, where a large quantity of water is used. Such processes are typically followed by a drying stage, which also requires manual handling and costly energy usage. Also, use of immersion and drying apparatuses generally requires a significant amount of floor space, which may be limited in a production facility. Furthermore, the immersion technique is less able to be controlled because the water and treatment to be applied may inevitably migrate into the glove during agitation, contacting the concealed surface that is not intended to be treated. Finally, the present invention offers greater flexibility in glove design. For instance, using the present method, it is possible to apply a treatment between polymeric dipping stages, so that the treatment is captured between durable layers of the glove. A treatment may also be applied while the glove matrix is tacky, which may, in some instances, improve transfer to the matrix and durability of the treatment on the finished article.

When the glove formation process is complete, the former assembly may be transferred to a stripping station where each glove is removed from the formers. The stripping station may involve automatic or manual removal of the glove from the former. For example, in one embodiment, the glove is manually removed and turned inside out as it is stripped from the former. By inverting the glove in this manner, the outside of the matrix becomes the interior surface of the glove. Thus, the exterior surface of the elastomeric article, for example, the glove, is exposed, while the interior surface is concealed. Any treatment, or combination of treatments, may then be applied to the untreated surface of the glove. If no further treatment is desired, the gloves are prepared for any additional processes, such as cleaning, stacking, and packaging.

Where additional treatment is necessary or desirable, the treatment may be applied to the glove using any suitable technique, for example, immersion or spraying. In some embodiments, a treatment that reduces glove bricking may be applied. As used herein, “bricking” refers to the tendency of the exterior surface of the glove to stick to itself. One treatment that may be suitable for such a purpose is a surfactant. Various surfactants may be applied to the exterior surface, including those characterized as cationic, nonionic, anionic, amphoteric, and so forth as described herein.

The invention may be embodied in other specific forms without departing from the scope and spirit of the inventive characteristics thereof. The present embodiments therefore are to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of treating an elastomeric matrix comprising:
(a) providing a transfer substrate including a treatment;
(b) providing the elastomeric matrix on a former, the matrix having an exposed surface; and
(c) contacting the matrix to the transfer substrate such that the treatment is transferred from the substrate to the exposed surface.

2. The method of claim 1, wherein the transfer substrate comprises an open cell material.

3. The method of claim 1, wherein the transfer substrate comprises a nonwoven material.

4. The method of claim 1, wherein the transfer substrate comprises a flexible bristle.

5. The method of claim 1, wherein the matrix is at least partially solidified.

6. The method of claim 1, wherein the treatment comprises a lubricant.

7. The method of claim 6, wherein the treatment comprises a silicone.

8. The method of claim 1, wherein the treatment comprises a skin health agent.

9. The method of claim 8, wherein the treatment is selected from the group consisting of an emollient, a humectant, a skin conditioner, an extract, or a combination thereof.

10. A method of treating a surface of an elastomeric matrix comprising:
(a) providing a transfer substrate;
(b) metering a treatment to the transfer substrate;
(c) providing the elastomeric matrix on a former, the matrix having an exposed surface; and
(d) contacting the matrix to the transfer substrate such that the treatment is transferred from the substrate to the exposed surface.

11. The method of claim 10, further comprising removing excess treatment from the transfer substrate.

12. A method of applying a treatment to a plurality of elastomeric matrices comprising:
(a) providing a conveyable assembly comprising a plurality of formers, each former coated with an elastomeric matrix;
(b) metering a treatment to a transfer substrate; and
(c) advancing the assembly to bring each elastomeric matrix into contact with the transfer substrate such that the treatment is transferred from the transfer substrate to each elastomeric matrix.

13. The method of claim 12, further comprising removing excess treatment from the transfer substrate.

14. A method of forming a treated elastomeric article comprising:
(a) providing a transfer substrate including a treatment;
(b) providing an elastomeric matrix on a former, the matrix having an exposed surface;
(c) contacting the matrix to the transfer substrate such that the treatment is transferred from the substrate to the exposed surface; and
(d) solidifying the matrix to form the treated article.

15. The method of claim 14, wherein the transfer substrate comprises an open cell material.

16. The method of claim 14, wherein the transfer substrate comprises a nonwoven material.

17. The method of claim 14, wherein the transfer substrate comprises a flexible bristle.

18. The method of claim 14, wherein the matrix is at least partially solidified.

19. The method of claim 14, wherein the exposed surface is an interior surface of the article.

20. The method of claim 14, wherein the treatment comprises a lubricant.

21. The method of claim 20, wherein the treatment comprises a silicone.

22. The method of claim 14, wherein the treatment comprises a skin health agent.

23. The method of claim 22, wherein the treatment is selected from the group consisting of an emollient, a humectant, a skin conditioner, an extract, or a combination thereof.

24. The method of claim 14, wherein the treatment comprises an antimicrobial agent.

25. The method of claim 14, wherein the treatment is transferred to the article at a level of from about 0.01 mass % to about 5.0 mass %.

26. The method of claim 14, wherein the treatment is transferred to the article at a level of from about 0.1 mass % to about 3.0 mass %.
